(19) United States
(12) Patent Application Publication
(10) Pub. No.: US 2026/0229615 A1
(43) Pub. Date: Aug. 6, 2026

(54) ENERGY STORAGE DEVICE

(71) Applicant: GS Yuasa International Ltd., Kyoto-shi (JP)

(72) Inventors: Ryoichi OKUYAMA, Kyoto-shi (JP); Kazuya OKABE, Kyoto-shi (JP)

(21) Appl. No.: 19/577,875

(22) Filed: Mar. 25, 2026

Related U.S. Application Data
(63) Continuation of application No. PCT/JP2024/032490, filed on Sep. 11, 2024.

(30) Foreign Application Priority Data
Sep. 26, 2023 (JP) 2023-163755

(51) Int. Cl. H01M 10/42; H01M 4/70; H01M 10/0525; H01M 10/0587

(52) U.S. Cl. CPC H01M 10/4214; H01M 4/70; H01M 10/0587; H01M 10/0525

(57) ABSTRACT

An energy storage device includes an electrode body that includes an electrode plate including a current collector foil and an active material layer. The electrode plate is wound around a winding axis extending in a first direction and includes an active material portion in which the active material layer is provided on the current collector foil in a second direction. The active material portion includes layers stacked in the second direction. Each of two or more continuous layers of the layers includes one or more electrode holes that are through holes penetrating the current collector foil and the active material layer. An opening area of each electrode hole is about 0.02 mm² or less. When viewed from the second direction, the electrode body includes an electrode hole group extending across each layer of the two or more layers, the electrode holes of each layer being located within a predetermined region.

### CROSS REFERENCE TO RELATED APPLICATIONS

This application claims the benefit of priority to Japanese Patent Application No. 2023-163755 filed on Sep. 26, 2023 and is a Continuation Application of PCT Application No. PCT/JP2024/032490 filed on Sep. 11, 2024. The entire contents of each application are hereby incorporated herein by reference.

### BACKGROUND OF THE INVENTION

### 1. Field of the Invention

The present invention relates to energy storage devices.

### 2. Description of the Related Art

Japanese Unexamined Patent Application Publication No. 2006-210031 discloses a winding type energy storage apparatus including a winding type electrode body formed by laminating and winding a positive electrode plate and a negative electrode plate with a separator interposed therebetween. The positive electrode plate has a plurality of positive electrode through-holes, which are arranged in a longitudinal direction thereof, the negative electrode plate has a plurality of negative electrode through-holes, which are arranged in a longitudinal direction thereof, and the positive electrode through-holes and the negative electrode through-holes overlap each other with the separator interposed therebetween to constitute a ventilation path communicating from the inside to the outer periphery of the electrode body.

### SUMMARY OF THE INVENTION

In an energy storage device including an electrode body in which electrode plates are wound, since it may be difficult to allow an electrolyte solution to permeate into the electrode body at the time of injecting the electrolyte solution, it is conceivable to form a through hole in the electrode body. In the winding type energy storage apparatus disclosed in Japanese Unexamined Patent Application Publication No. 2006-210031, since the ventilation path is formed in the winding type electrode body, it is conceivable to permeate the electrolyte solution into the winding type electrode body from the ventilation path. However, in this winding type energy storage apparatus, there is a possibility that defects such as generation of burrs or contamination (metal powder, etc.) due to formation of ventilation path or a decrease in capacity occurs, and a configuration is desired that allows the electrolyte solution to easily permeate the electrode body while reducing or preventing the occurrence of such defects.

Example embodiments of the present invention provide energy storage devices that each allows an electrolyte solution to easily permeate an electrode body while reducing or preventing defects.

An energy storage device according to an example embodiment of the present invention includes an electrode body that includes an electrode plate including a current collector foil and an active material layer, the electrode plate is wound around a winding axis extending in a first direction and includes an active material portion in which the active material layer is provided on the current collector foil in a second direction orthogonal to the first direction, the active material portion includes a plurality of layers in the second direction, each layer of two or more continuous layers among the plurality of layers includes one or more electrode holes that are through holes penetrating both the current collector foil and the active material layer, an opening area of the electrode hole is about 0.02 mm² or less, and when viewed from the second direction, the electrode body includes an electrode hole group extending across each layer of the two or more layers, the electrode holes of each layer being located within a predetermined region.

According to each of energy storage devices of example embodiments of the present invention, an electrolyte solution can be easily permeated into an electrode body while reducing or preventing defects.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an external appearance of an energy storage device according to an example embodiment of the present invention.

FIG. 2 is an exploded perspective view illustrating elements obtained by disassembling an energy storage device according to an example embodiment of the present invention.

FIG. 3 is a perspective view and a cross-sectional view illustrating a configuration of an electrode body according to an example embodiment of the present invention.

FIG. 4 is a perspective view illustrating a configuration in a state where a winding state of an electrode plate in an electrode body according to an example embodiment is partially developed.

FIG. 5 is a front view illustrating configurations of electrode holes and electrode hole groups of an electrode body according to an example embodiment of the present invention.

FIGS. 6A and 6B are a front view and a cross-sectional view illustrating enlarged configurations of a portion of the electrode holes and the electrode hole groups of an electrode body according to an example embodiment of the present invention.

FIG. 7 is a front view illustrating configurations of electrode holes and electrode hole groups of an electrode body according to Modification Example 1 of an example embodiment of the present invention.

FIG. 8 is a front view illustrating configurations of electrode holes and electrode hole groups of an electrode body according to Modification Example 2 of an example embodiment of the present invention.

FIG. 9 is a front view illustrating configurations of electrode holes and electrode hole groups of an electrode body according to Modification Example 3 of an example embodiment of the present invention.

FIG. 10 is a front view illustrating configurations of electrode holes and electrode hole groups of an electrode body according to Modification Example 4 of an example embodiment of the present invention.

FIG. 11 is a perspective view illustrating a configuration of electrode holes included in an electrode hole group of an electrode body according to Modification Example 5 of an example embodiment of the present invention.

FIG. 12 is a plan view illustrating an example of an energy storage apparatus according to Modification Example 6 of an example embodiment of the present invention.

### DETAILED DESCRIPTION OF THE EXAMPLE EMBODIMENTS

(1) An energy storage device according to an example embodiment of the present invention includes an electrode body that includes an electrode plate including a current collector foil and an active material layer, the electrode plate is wound around a winding axis extending in a first direction and includes an active material portion in which the active material layer is provided on the current collector foil in a second direction orthogonal to the first direction, the active material portion includes a plurality of layers in the second direction, each layer of two or more continuous layers among the plurality of layers includes one or more electrode holes, which are through holes penetrating both the current collector foil and the active material layer, an opening area of each electrode hole is about 0.02 mm² or less, and when viewed from the second direction, the electrode body includes an electrode hole group extending across each layer of the two or more layers, the electrode holes of each layer being located within a predetermined region.

Accordingly, the energy storage device includes an electrode body in which each layer of two or more continuous layers of an active material portion of a wound electrode plate includes electrode hole having an opening area of about 0.02 mm² or less, the electrode body including therein the electrode hole group in which the electrode holes of each layer are located so as to be densely arranged within the predetermined region when viewed from the second direction. Although it is difficult for the electrolyte solution to permeate into the electrode body in which the electrode plates are wound, the formation of the electrode hole group in the electrode body, in which the electrode hole of each layer of the active material portion are densely arranged within the predetermined region, allows the electrolyte solution to easily permeate into the electrode body via the respective electrode holes of the electrode hole group. Since the electrode hole is a minute electrode hole with an opening area of about 0.02 mm² or less, it is possible to reduce or prevent defects such as a risk of a micro short circuit occurring due to burrs or contamination, or a decrease in capacity (decrease in energy density) due to a decrease in an effective electrode area. Thus, the electrolyte solution can be easily permeated into the electrode body while reducing or preventing defects.

(2) In the energy storage device according to the above (1), a maximum width of the predetermined region may be smaller than about 50 mm when viewed from the second direction.

Accordingly, by setting the maximum width of the predetermined region in which the electrode holes of each layer in the electrode hole group are densely arranged to be smaller than about 50 mm, the electrode holes of each layer are brought closer to each other to improve permeability of the electrolyte solution into each layer via the electrode holes.

(3) In the energy storage device according to the above (1) or (2), in the electrode hole group, the each layer of the two or more layers may include a plurality of the electrode holes.

Accordingly, by providing the plurality of electrode holes in the each layer of the electrode hole group, the electrolyte solution can be efficiently permeated into each layer via the plurality of electrode holes.

(4) In the energy storage device according to any one of the above (1) to (3), the electrode plate may include a positive electrode plate and a negative electrode plate, and in the electrode hole group, the electrode holes may be provided in all layers of a plurality of layers of an active material portion of the positive electrode plate and a plurality of layers of an active material portion of the negative electrode plate.

Accordingly, in the electrode hole group, by providing the electrode holes in all layers of the active material portions of the positive electrode plate and the negative electrode plate, the electrolyte solution can be permeated into all layers of the positive electrode plate and the negative electrode plate to enable the electrolyte solution to be more effectively permeated into the electrode body.

(5) In the energy storage device according to any one of the above (1) to (4), a ratio of a total opening area of all the electrode holes provided in the active material portion to an area of the active material portion may be about 3% or less.

Accordingly, by setting the ratio of the total opening area of all the electrode holes to the area of the active material portion to be as small as about 3% or less, a decrease in the effective electrode area caused by providing the electrode holes in the active material portion can be reduced or prevented.

(6) In the energy storage device according to any one of the above (1) to (5), two or more of electrode hole groups included in the electrode hole group may be located in the electrode body, and a distance between the electrode holes within the electrode hole group may be smaller than a distance between two adjacent electrode hole groups included the electrode hole group when viewed from the second direction.

Accordingly, since the distance between the electrode holes in the electrode hole group is relatively small, the electrolyte solution can be effectively permeated into the electrode body. Since the distance between the two adjacent electrode hole groups is relatively large, damage to the electrode plate, such as breakage of the electrode plate between the two electrode hole groups, can be reduced or prevented.

(7) In the energy storage device according to the above (6), a distance between the two adjacent electrode hole groups in the first direction may be defined as a first distance, a distance between the two adjacent electrode hole groups in a third direction orthogonal to the first direction and the second direction may be defined as a second distance, and the first distance may be larger than the second distance.

Accordingly, the first distance between the two electrode hole groups in the first direction is made larger than the second distance between the two electrode hole groups in the third direction. In this way, by distributing the electrode hole groups at a constant distance (the first distance in the first direction and the second distance in the third direction), a decrease in the effective electrode area caused by providing the electrode holes can be reduced or prevented. By increasing the distance between the electrode hole groups in the first direction (first distance), damage to the electrode plate, such as breakage of the electrode plate between the electrode hole groups, can be further reduced or prevented.

(8) In the energy storage device according to the above (7), the first distance may be larger than about 10 times the second distance.

Accordingly, by setting the first distance to be larger than about 10 times the second distance, the electrode hole groups are distributed at large intervals in the first direction, so that a decrease in the effective electrode area caused by providing the electrode holes can be further reduced or prevented. By setting the first distance to be larger than about 10 times the second distance, the distance between the electrode hole groups in the first direction is further increased to further reduce or prevent damage to the electrode plate, such as breakage of the electrode plate between the electrode hole groups.

Hereinafter, energy storage devices according to example embodiments (including modification examples thereof) of the present invention will be described with reference to the drawings. Each of the example embodiments to be described below illustrates a comprehensive or specific example. A numerical value, a shape, a material, an element, a position of arrangement and a form of connection of the elements, a manufacturing process, an order of the manufacturing processes, and the like, which are described in the following example embodiments, are merely examples, and are not intended to limit the present invention. In each of the drawings, dimensions and the like are not strictly illustrated. In the drawings, the same or corresponding elements are denoted by the same reference numerals.

In the following description and drawings, a direction in which a pair of terminals (positive and negative; the same applies hereinafter) of the energy storage device are arranged, a direction in which a pair of current collectors are arranged, a winding axis direction of the electrode body, a direction in which the electrode body or the container extends (a direction in which a width is largest), or a direction in which a pair of short side surfaces of the container face each other is defined as an X-axis direction. A thickness direction of the container (a direction in which the width of the container becomes shortest), a direction in which a pair of long side surfaces of the container face each other, or a direction in which a pair of flat portions of the electrode body face each other is defined as a Y-axis direction. A direction in which a container body and a lid body of the container are arranged, a direction in which a pair of curved portions of the electrode body face, or an up-down direction is defined as a Z-axis direction. The X-axis direction, the Y-axis direction, and the Z-axis direction are directions intersecting each other (orthogonal to each other in the present example embodiment). Although there may be cases where the Z-axis direction does not correspond to the up-down direction depending on a usage mode, the Z-axis direction is described as the up-down direction in the following description for convenience of explanation.

In the following description, an X-axis positive direction indicates a direction of an arrow in the X-axis, and an X-axis negative direction indicates a direction opposite to the X-axis positive direction. When the direction is simply referred to as the X-axis direction, it indicates both of or one of the X-axis positive direction and the X-axis negative direction. The same applies to the Y-axis direction and the Z-axis direction. Hereinafter, the X-axis direction is also referred to as a first direction, the Y-axis direction is also referred to as a second direction, and the Z-axis direction is also referred to as a third direction. Expressions indicating relative directions or orientations, such as parallel and orthogonal, include cases that are not strictly such directions or orientations. Two directions being parallel to each other means not only that the two directions are completely parallel to each other, but also that the two directions are substantially parallel to each other, that is, for example, including a difference of several percent or thereabouts. In the following description, when the expression “insulation/insulating” is used, “insulation/insulating” is intended as “electrical insulation”. The material having insulating properties is preferably formed of a material having a volume resistivity of 1×10¹⁰ Ωm or more.

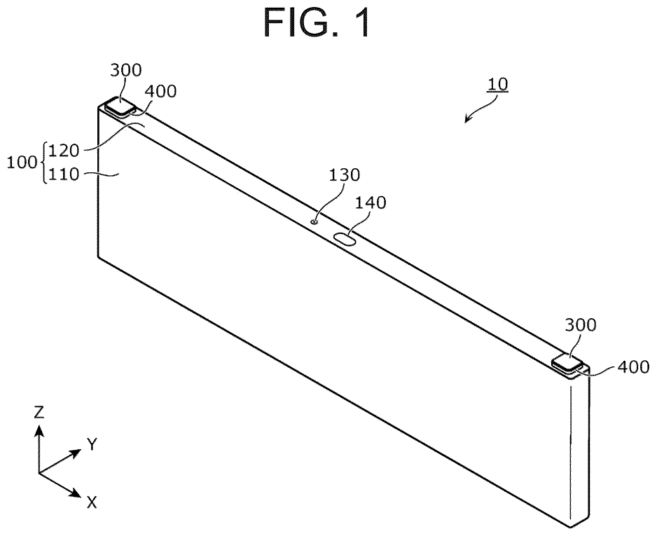

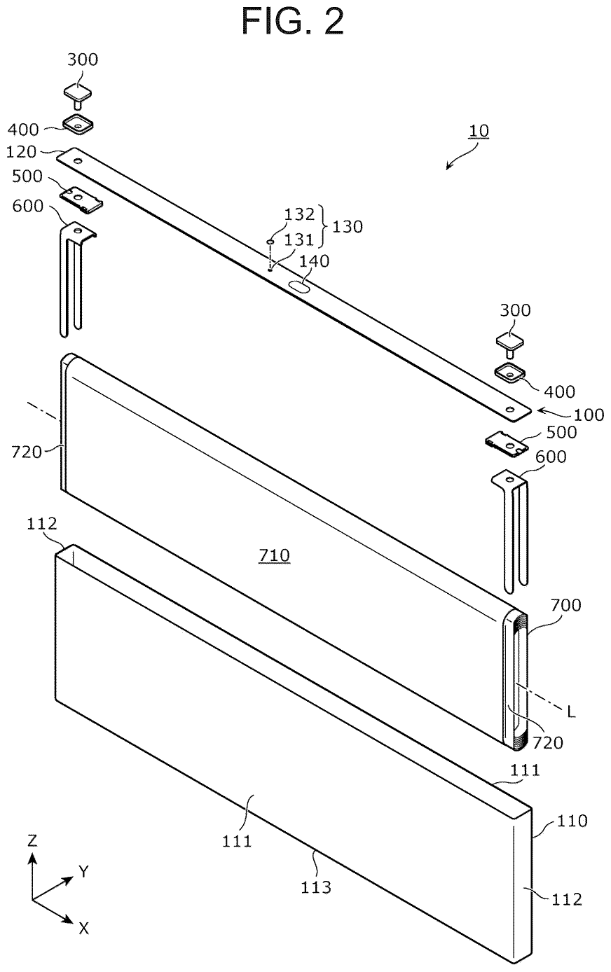

First, a general description of an energy storage device 10 in the present example embodiment will be given with reference to FIGS. 1 and 2. FIG. 1 is a perspective view illustrating an external appearance of the energy storage device 10 according to the present example embodiment. FIG. 2 is an exploded perspective view illustrating elements obtained by disassembling the energy storage device 10 according to the present example embodiment.

The energy storage device 10 is a secondary battery (a single battery) capable of charging electricity and discharging electricity, and more specifically, is a non-aqueous electrolyte secondary battery such as a lithium-ion secondary battery. The energy storage device 10 is used as a battery or the like for driving or engine starting of a mobile object such as an automobile, a motorcycle, a watercraft, a ship, a snowmobile, an agricultural machine, a construction machine, an automated guided vehicle (AGV), or a railway vehicle for an electric railway. As the above-mentioned automobiles, electric vehicles (EVs), hybrid electric vehicles (HEVs), plug-in hybrid electric vehicles (PHEVs), and fossil fuel (gasoline, light oil, liquefied natural gas, etc.) automobiles are exemplified. As the above-mentioned railway vehicle for electric railway, a train, a monorail, a magnetic levitation train, and a hybrid train provided with both a diesel engine and an electric motor are exemplified. The energy storage device 10 can also be used as a stationary battery or the like that is used for home, business, or the like.

The energy storage device 10 is not limited to a non-aqueous electrolyte secondary battery, and may be a secondary battery other than the non-aqueous electrolyte secondary battery, or may be a capacitor. The energy storage device 10 may be a primary battery instead of a secondary battery. The energy storage device 10 may be a pouch-type energy storage device. In the present example embodiment, the energy storage device 10 having a rectangular parallelepiped shape (prismatic shape) flattened in the Y-axis direction is illustrated, but the shape of the energy storage device 10 is not limited to the rectangular parallelepiped shape, and may be a polygonal prism shape other than the rectangular parallelepiped shape, an oblong cylindrical shape, an elliptical cylindrical shape, a cylindrical shape, or the like.

As illustrated in FIG. 1, the energy storage device 10 includes a container 100, a pair of (positive and negative) terminals 300, and a pair of (positive and negative) upper gaskets 400. As illustrated in FIG. 2, the energy storage device 10 further includes a pair of (positive and negative) lower gaskets 500, a pair of (positive and negative) current collectors 600, and an electrode body 700, which are accommodated inside the container 100. In addition to the above elements, there may be provided a spacer disposed on the side of or below the electrode body 700, an insulating film that wraps the electrode body 700, or the like.

While an electrolyte solution (non-aqueous electrolyte) is sealed inside the container 100, illustration thereof is omitted. The type of the electrolyte solution is not particularly limited as long as the performance of the energy storage device 10 is not impaired, and various electrolyte solutions can be selected. The electrolyte solution contains a non-aqueous solvent and an electrolyte salt dissolved in the non-aqueous solvent. The non-aqueous solvent can be appropriately selected from known non-aqueous solvents. Examples of non-aqueous solvents include cyclic carbonates such as ethylene carbonate (EC) or propylene carbonate (PC), chain carbonates such as ethyl methyl carbonate (EMC), carboxylic acid esters, phosphoric acid esters, sulfonic acid esters, ethers, amides, and nitriles. As the non-aqueous solvent, a compound obtained by substituting a part of hydrogen atoms contained in these compounds with halogen may be used. The electrolyte salt can be appropriately selected from known electrolyte salts. Examples of electrolyte salts include lithium salts, such as inorganic lithium salts such as LiPF₆, sodium salts, potassium salts, magnesium salts, and onium salts. Among them, a lithium salt is preferable. The electrolyte solution may contain an additive such as biphenyl in addition to the non-aqueous solvent and the electrolyte salt.

The container 100 is a rectangular parallelepiped (prismatic or box-shaped) case including a container body 110 having an opening formed in a Z-axis positive direction and a lid body 120 closing the opening of the container body 110. The lid body 120 is a flat plate-like and rectangular member of a lid portion of the container 100, and is disposed in the Z-axis positive direction of the container body 110. The lid body 120 is a wall portion extending in a winding axis direction of the electrode body 700. The winding axis direction of the electrode body 700 is a direction in which a winding axis L of the electrode body 700 described below extends, and is the X-axis direction in the present example embodiment.

The container body 110 is a rectangular cylindrical member having a bottom, of a main body portion of the container 100. The container body 110 includes a pair of long side wall portions 111 on surfaces (side surfaces) on both sides in the Y-axis direction, a pair of short side wall portions 112 on surfaces (side surfaces) on both sides in the X-axis direction, and a bottom wall portion 113 on a surface (bottom surface) in a Z-axis negative direction. The long side wall portion 111 is a flat plate-like and rectangular wall portion extending in the X-axis direction (the winding axis direction of the electrode body 700), and includes a long side surface of the container 100. The long side wall portion 111 is adjacent to the short side wall portion 112, the bottom wall portion 113, and the lid body 120, and has an area larger than that of the short side wall portion 112. The short side wall portion 112 is a flat plate-like and rectangular wall portion extending in the Z-axis direction, and includes a short side surface of the container 100. The short side wall portion 112 is adjacent to the long side wall portion 111, the bottom wall portion 113, and the lid body 120, and has an area smaller than that of the long side wall portion 111. The bottom wall portion 113 is a flat plate-like and rectangular wall portion extending in the X-axis direction (the winding axis direction of the electrode body 700), and includes a bottom surface of the container 100. The bottom wall portion 113 is disposed adjacent to the long side wall portion 111 and the short side wall portion 112.

The inside of the container 100 is sealed (hermetically sealed) by joining the container body 110 and the lid body 120 by welding or the like after the electrode body 700 and the like are accommodated in the container body 110. The material of the container 100 (the container body 110 and the lid body 120) is not particularly limited, and may be a weldable (joinable) metal such as stainless steel, aluminum, aluminum alloy, iron, or plated steel sheet, or a resin may be used. The container body 110 and the lid body 120 may be formed of the same material or different materials. When the energy storage device 10 is a pouch-type energy storage device, the container 100 may be a laminate film including a plurality of layers including a metal layer and a resin layer.

A liquid injection part 130 and a gas discharge valve 140 are formed in the container 100. In the present example embodiment, the liquid injection part 130 and the gas discharge valve 140 are formed in the lid body 120. That is, the liquid injection part 130 and the gas discharge valve 140 are formed on the wall portion extending in the winding axis direction (X-axis direction) of the electrode body 700. The gas discharge valve 140 is a safety valve that releases pressure inside the container 100 when the pressure is raised excessively. In the present example embodiment, the gas discharge valve 140 is disposed at the center of the lid body 120 in the X-axis direction and the center thereof in the Y-axis direction, but may be disposed at any position of the lid body 120.

The liquid injection part 130 is a part for injecting the electrolyte solution into the container 100 at the time of manufacturing the energy storage device 10. The liquid injection part 130 is used for evacuating the inside of the container 100, injecting the electrolyte solution into the container 100 to impregnate the inside of the electrode body 700 with the electrolyte solution, or degassing gas from the inside of the electrode body 700 at the time of manufacturing the energy storage device 10. In the present example embodiment, the liquid injection part 130 is disposed closer to the X-axis negative direction of the lid body 120 and at the center thereof in the Y-axis direction, but may be disposed at any position of the lid body 120.

The liquid injection part 130 includes a liquid injection port 131 and a liquid injection plug 132. The liquid injection port 131 is a through hole formed in the lid body 120 for injecting the electrolyte solution into the container 100, and has a circular shape in the present example embodiment. The liquid injection plug 132 is a member that closes the liquid injection port 131. Specifically, the liquid injection plug 132 is a closing member (lid member) that is joined to the lid body 120 to close the liquid injection port 131 after the inside of the container 100 is evacuated from the liquid injection port 131 and the electrolyte solution is injected into the container 100 at the time of manufacturing the energy storage device 10. The material of the liquid injection plug 132 is not particularly limited, but any metal or the like applicable to the container 100 (lid body 120) can be used. In particular, the liquid injection plug 132 is formed of a material that can be welded to the lid body 120, such as the same material as the lid body 120.

The terminals 300 are electrode terminals (a positive electrode terminal and a negative electrode terminal) electrically connected to the electrode body 700 via the current collector 600. The terminal 300 is a metal member for leading electricity stored in the electrode body 700 to an external space of the energy storage device 10 and for introducing electricity into an internal space of the energy storage device 10 to store electricity in the electrode body 700. The terminal 300 is formed of a conductive member including a metal such as aluminum, aluminum alloy, copper, or copper alloy. The terminal 300 is connected (joined) to the current collector 600 by swaging, welding, or the like, and is attached to the lid body 120. The terminal 300 is disposed so as to protrude in the Z-axis positive direction from the outer surface (the surface in the Z-axis positive direction) of the lid body 120. In the present example embodiment, the terminal 300 is a weld terminal joined to a conductive member such as an external bus bar by welding, but the terminal 300 may be a bolt terminal that includes a bolt portion on which a male screw portion projecting in the Z-axis positive direction is formed and that is joined to the conductive member by bolt coupling.

The current collectors 600 are disposed on both sides of the electrode body 700 in the X-axis direction, are connected (joined) to the electrode body 700 and the terminals 300, and are conductive current collecting members (a positive electrode current collector and a negative electrode current collector) that electrically connect the electrode body 700 and the terminals 300. The current collector 600 is connected (joined) to an active material non-forming portion 720 of the electrode body 700 described below by welding, swaging, or the like, and as described above, is connected (joined) to the terminal 300 by swaging, welding, or the like, thereby being fixed to the lid body 120. Although the material of the current collector 600 is not particularly limited, in the present example embodiment, the positive electrode current collector 600 is formed of aluminum, an aluminum alloy, or the like, similarly to a positive electrode current collector foil 741 of the electrode body 700 described below, and the negative electrode current collector 600 is formed of copper, a copper alloy, or the like, similarly to a negative electrode current collector foil 751 of the electrode body 700 described below.

The upper gasket 400 is a plate-like and rectangular gasket disposed between the lid body 120 of the container 100 and the terminal 300 and responsible for insulation and sealing between the lid body 120 and the terminal 300. The lower gasket 500 is a plate-like and rectangular gasket disposed between the lid body 120 and the current collector 600 and insulating between the lid body 120 and the current collector 600. The upper gasket 400 and the lower gasket 500 are formed of an insulating member such as polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), ABS resin, or a composite material thereof.

The electrode body 700 is an energy storage element (power generating element) formed by laminating an electrode plate and a separator and capable of storing electricity. In the present example embodiment, the electrode body 700 is formed by winding an electrode plate and a separator. The electrode body 700 has an elongated shape extending in the X-axis direction, and has an oblong cylindrical shape (oblong shape when viewed from the X-axis direction). The electrode body 700 includes an electrode body main portion 710 and active material non-forming portions 720 protruding from the electrode body main portion 710 on both sides in the X-axis direction, the active material non-forming portions 720 being connected (joined) to the current collectors 600 as described above. An electrode hole group 730 including a plurality of electrode holes 731 described below is formed in the electrode body main portion 710. Such a configuration of the electrode body 700 will be described in detail below.

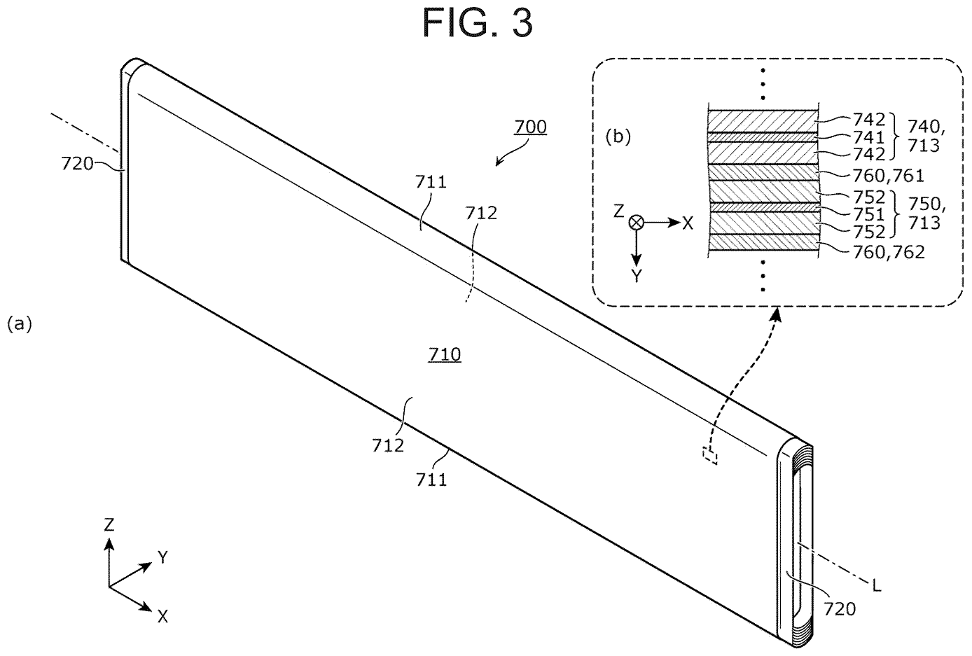

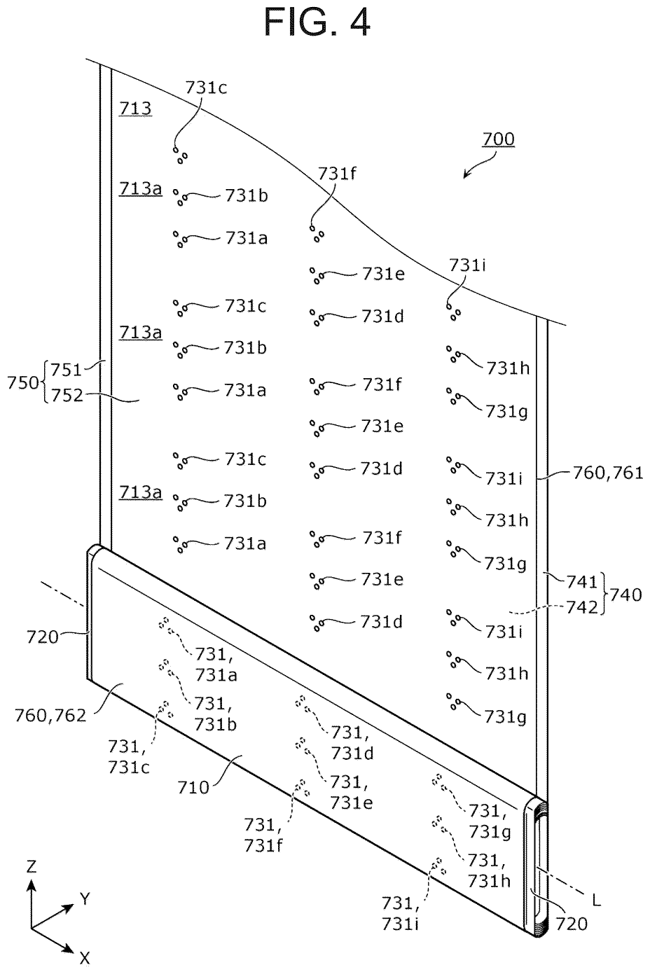

FIG. 3 is a perspective view and a cross-sectional view illustrating a configuration of the electrode body 700 according to the present example embodiment. FIG. 3A is a perspective view illustrating an external appearance of the electrode body 700, and FIG. 3B is a cross-sectional view illustrating a laminated state of electrode plates by enlarging a cross section of a part of the electrode body 700. FIG. 4 is a perspective view illustrating a configuration in a state where the winding state of the electrode plate in the electrode body 700 according to the present example embodiment is partially developed.

As illustrated in FIGS. 3 and 4, the electrode body 700 includes a positive electrode plate 740 and a negative electrode plate 750, which are two electrode plates, as electrode plates, and includes separators 761 and 762, which are two separators 760, as separators.

The positive electrode plate 740 is an electrode plate in which a positive electrode active material layer 742 is formed on a surface of a positive electrode current collector foil 741 which is a long strip-shaped current collector foil (metal foil) made of metal such as aluminum or aluminum alloy. The negative electrode plate 750 is an electrode plate in which a negative electrode active material layer 752 is formed on a surface of a negative electrode current collector foil 751 which is a long strip-shaped current collector foil (metal foil) made of metal such as copper or copper alloy. As the positive electrode current collector foil 741 and the negative electrode current collector foil 751, known materials can be appropriately used as long as the materials are stable against oxidation-reduction reactions during charge and discharge, such as nickel, iron, stainless steel, titanium, baked carbon, conductive polymer, conductive glass, or Al-Cd alloy. As the positive electrode active material used for the positive electrode active material layer 742 and the negative electrode active material used for the negative electrode active material layer 752, known materials can be appropriately used as long as the materials are capable of absorbing and releasing charge transport ions.

As the positive electrode active material, polyanion compounds such as LiMPO₄, LiMSiO₄, and LiMBO₃ (M is one or more transition metal elements selected from Fe, Ni, Mn, Co, etc.), lithium titanate, spinel type lithium manganese oxides such as LiMn₂O₄ or LiMn_{1.5}Ni_{0.5}O₄, lithium transition metal oxides such as LiMO₂ (M is one or more transition metal elements selected from Fe, Ni, Mn, Co, etc.), and the like can be used. Examples of negative electrode active materials include lithium metal, lithium alloys (lithium metal-including alloys such as lithium-silicon, lithium-aluminum, lithium-lead, lithium-tin, lithium-aluminum-tin, lithium-gallium, and Wood's alloy), alloys capable of absorbing and releasing lithium, carbon materials (such as graphite, non-graphitizable carbon, graphitizable carbon, low-temperature fired carbon, and amorphous carbon), silicon oxides, metal oxides, lithium metal oxides (such as Li₄Ti₅O₁₂), polyphosphoric acid compounds, and compounds of a transition metal and a Group 14 to Group 16 element, such as Co₃O₄ or Fe₂P, which are generally called conversion negative electrodes.

The separator 760 (separators 761 and 762) is a microporous insulating sheet made of resin or the like. As materials of the separator 760, known materials can be appropriately used as long as the performance of the energy storage device 10 is not impaired. As the separator 760, examples include woven fabric, nonwoven fabric, porous resin films, and the like. Among these examples, the porous resin film is preferable from the viewpoint of strength, and the nonwoven fabric is preferable from the viewpoint of liquid retention of the electrolyte solution. As materials of the separator 760, polyolefins such as polyethylene or polypropylene are preferable from the viewpoint of a shutdown function, and polyimide, aramid, or the like are preferable from the viewpoint of oxidative decomposition resistance. As the separator 760, a material obtained by combining these resins may be used. The separators 761 and 762 may be formed of the same material or different materials.

The electrode body 700 is formed by alternately laminating and winding the positive electrode plate 740 and the negative electrode plate 750 configured as described above, and the separators 761 and 762. That is, the electrode body 700 is formed by laminating and winding the positive electrode plate 740, the separator 761, the negative electrode plate 750, and the separator 762 in this order (see FIG. 3B, etc.). In the present example embodiment, the electrode body 700 is a winding type electrode body formed by winding the positive electrode plate 740, the negative electrode plate 750, and the like around a winding axis L extending in the X-axis direction (first direction). The winding axis L is a virtual axis serving as a central axis when winding the positive electrode plate 740, the negative electrode plate 750, and the like, and in the present example embodiment, is a straight line passing through the center of the electrode body 700 and parallel to the X-axis direction.

Specifically, in the electrode body 700, the positive electrode plate 740 and the negative electrode plate 750 are wound so as to be shifted from each other in a direction along the winding axis L (winding axis direction, X-axis direction in the present example embodiment) with the separators 761 and 762 interposed therebetween. The positive electrode plate 740 and the negative electrode plate 750 include, at ends in the shifted directions, respectively, an active material non-forming portion 720 in which the positive electrode active material layer 742 and the negative electrode active material layer 752 are not formed (coated) and the positive electrode current collector foil 741 and the negative electrode current collector foil 751 are exposed. That is, the electrode body 700 includes a positive electrode active material non-forming portion 720 in which ends of the positive electrode current collector foil 741 are laminated and bundled at one end in the winding axis direction, and a negative electrode active material non-forming portion 720 in which ends of the negative electrode current collector foil 751 are laminated and bundled at the other end in the winding axis direction.

As described above, the electrode body 700 includes an electrode body main portion 710 of a main body of the electrode body 700, and a pair of (positive and negative) active material non-forming portions 720 protruding from the electrode body main portion 710 on both sides in the X-axis direction. The electrode body main portion 710 is an oblong cylindrical portion formed by winding an active material portion 713 of the electrode plates (the positive electrode plate 740 and the negative electrode plate 750) and the separator 760. The active material portion 713 is a portion in which the active material layers (the positive electrode active material layer 742 and the negative electrode active material layer 752) are formed (coated) in a second direction (the Y-axis direction in FIG. 3B)) orthogonal to the first direction of the current collector foils (the positive electrode current collector foil 741 and the negative electrode current collector foil 751) of the electrode plates (the positive electrode plate 740 and the negative electrode plate 750). Thus, the electrode body main portion 710 includes a pair of curved portions 711 on both sides in the Z-axis direction and a pair of flat portions 712 on both sides in the Y-axis direction (see FIG. 3A). That is, the electrode body 700 includes curved portions 711 having a curved shape and flat portions 712 having a flat shape, which are formed by winding the positive electrode plate 740 and the negative electrode plate 750 around the winding axis L.

The curved portion 711 is a portion having a curved shape, which is curved in a semicircular arc shape so as to protrude in the Z-axis direction when viewed from the X-axis direction and extends in the X-axis direction, and is disposed to face the bottom wall portion 113 of the container body 110 and the lid body 120. That is, the pair of curved portions 711 are portions that are curved so as to protrude on both sides in the Z-axis direction toward the bottom wall portion 113 of the container body 110 and the lid body 120 when viewed from the X-axis direction. The flat portion 712 is a rectangular and flat portion connecting ends of the pair of curved portions 711 and spreading in parallel to an XZ plane facing the Y-axis direction, and is disposed to face the long side wall portions 111 on both sides of the container body 110 in the Y-axis direction. The curved shape of the curved portion 711 is not limited to a semicircular arc shape, and may be a part of an elliptical shape or the like, and may be curved in any manner. The flat portion 712 is not limited to having a flat outer surface facing the Y-axis direction, and the outer surface may be slightly recessed or slightly swollen.

With the configuration described above, the electrode body 700 has an elongated (horizontally long) shape with a long length in the winding axis direction (X-axis direction). That is, the length of the electrode body 700 in the X-axis direction is longer than the lengths of the electrode body 700 in both the Y-axis direction and the Z-axis direction. In the present example embodiment, the length of the electrode body 700 in the X-axis direction is preferably 300 mm or more, more preferably 500 mm or more, and further preferably 1000 mm or more, but may be shorter than 300 mm. In the present example embodiment, the length of the electrode body 700 in the X-axis direction is 1500 mm or less, but may be longer than 1500 mm.

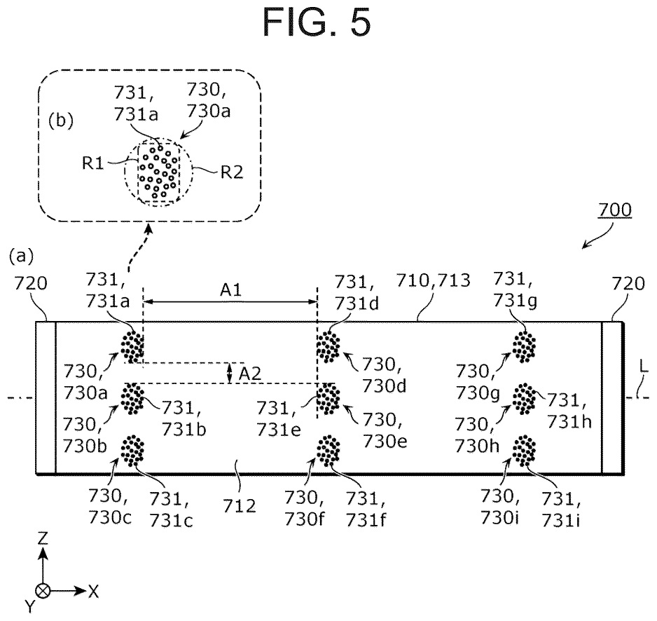

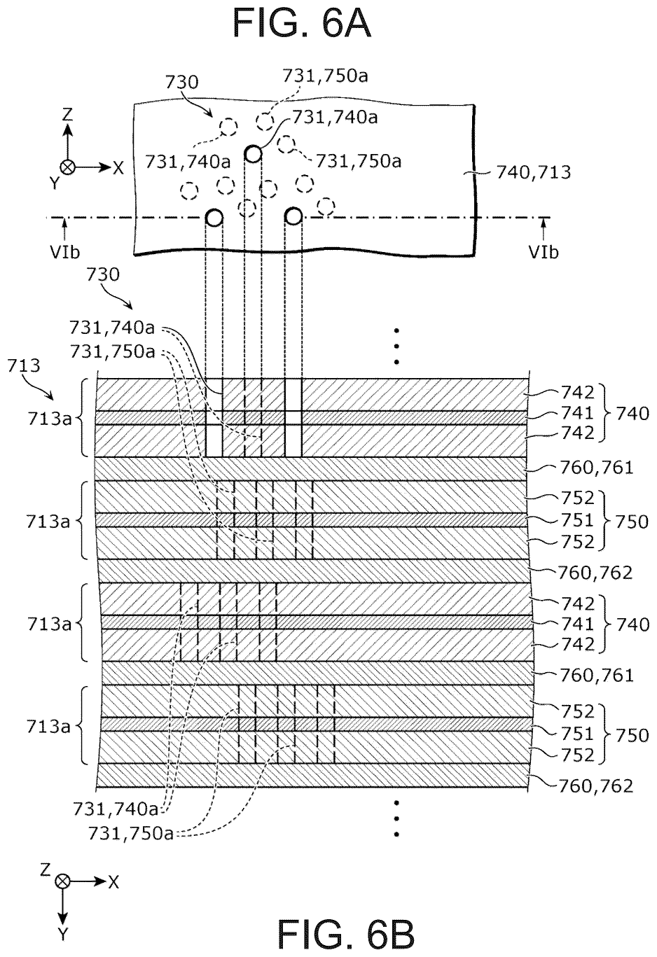

Further, as illustrated in FIG. 4, a plurality of electrode holes 731 are formed in the active material portion 713 of the electrode body main portion 710 of the electrode body 700. In FIGS. 2 and 3, the electrode holes 731 are not illustrated because the electrode holes 731 are hidden by the separator 760. In FIG. 4, the electrode holes 731 hidden by the separator 760 are indicated by dotted lines. FIG. 4 is a conceptual diagram illustrating the arrangement, shape, and the like of the electrode holes 731, and illustrates the size of the electrode holes 731 larger than the actual size as compared with FIG. 5 and the like described below. In the present example embodiment, the plurality of electrode holes 731 are densely arranged within a predetermined region when viewed from the Y-axis direction in a state where the electrode plates (the positive electrode plate 740 and the negative electrode plate 750) and the separator 760 of the electrode body 700 are viewed through, whereby an electrode hole group 730 (see FIG. 5) including the plurality of electrode holes 731 is formed. Hereinafter, configurations of the electrode holes 731 and the electrode hole groups 730 will be described in detail with reference to FIGS. 5 and 6 as well.

FIG. 5 is a front view illustrating configurations of the electrode holes 731 and the electrode hole groups 730 of the electrode body 700 according to the present example embodiment. FIG. 5A is a view of the electrode body 700 viewed from the Y-axis negative direction, and FIG. 5B illustrates enlarged configurations of the electrode holes 731 and the electrode hole groups 730. In FIG. 5, for convenience of explanation, the electrode holes 731 and the electrode hole groups 730 formed in the flat portion 712 of the electrode body main portion 710 in the Y-axis negative direction are illustrated as viewed through the electrode plates (the positive electrode plate 740 and the negative electrode plate 750) and the separator 760 of the electrode body 700. FIGS. 6A and 6B are front views and cross-sectional views illustrating enlarged configurations of a part of the electrode holes 731 and the electrode hole groups 730 of the electrode body 700 according to the present example embodiment. FIG. 6A is a front view of a part of the configurations of the electrode holes 731 and the electrode hole groups 730, as viewed from the Y-axis negative direction, and FIG. 6B is a cross-sectional view illustrating a VIb-VIb cross section in FIG. 6A. Other electrode holes 731 and electrode hole groups 730 not illustrated in FIGS. 6A and 6B also have the same configuration as the electrode holes 731 and the electrode hole groups 730 illustrated in FIGS. 6A and 6B.

As described above, the electrode plates of the electrode body 700 include the active material portion 713 in which the active material layer is formed in the second direction of the current collector foil (the Y-axis direction in FIGS. 6A and 6B). Since the electrode plates include the positive electrode plate 740 and the negative electrode plate 750, the positive electrode plate 740 includes a positive electrode active material portion 713 in which the positive electrode active material layer 742 is formed in the second direction (Y-axis direction in FIGS. 6A and 6B) of the positive electrode current collector foil 741, and the negative electrode plate 750 includes a negative electrode active material portion 713 in which the negative electrode active material layer 752 is formed in the second direction (Y-axis direction in FIGS. 6A and 6B) of the negative electrode current collector foil 751. That is, the positive electrode current collector foil 741 and the positive electrode active material layer 742 of the positive electrode plate 740, excluding the positive electrode active material non-forming portion 720, are referred to as the positive electrode active material portion 713. The negative electrode current collector foil 751 and the negative electrode active material layer 752 of the negative electrode plate 750, excluding the negative electrode active material non-forming portion 720, are referred to as the negative electrode active material portion 713. In other words, a portion of the positive electrode plate 740 other than the positive electrode active material non-forming portion 720 is referred to as the positive electrode active material portion 713, and a portion of the negative electrode plate 750 other than the negative electrode active material non-forming portion 720 is referred to as the negative electrode active material portion 713.

In the present example embodiment, since the electrode plates (the positive electrode plate 740 and the negative electrode plate 750) are wound, the active material portion 713 is also wound. Thus, as illustrated in FIGS. 6A and 6B, the active material portion 713 constitutes a plurality of layers 713a in the Y-axis direction (second direction). In other words, the active material portion 713 includes a plurality of layers 713a laminated in the Y-axis direction (second direction). That is, in the positive electrode plate 740, three layers, in which the positive electrode active material layers 742 (two layers) are formed on both surfaces of the positive electrode current collector foil 741 (one layer) in the Y-axis direction, are defined as one unit, and are referred to as one layer 713a (positive electrode layer 713a). In the negative electrode plate 750, three layers, in which the negative electrode active material layers 752 (two layers) are formed on both surfaces of the negative electrode current collector foil 751 (one layer) in the Y-axis direction, are defined as one unit, and are referred to as one layer 713a (negative electrode layer 713a). As described above, by winding the positive electrode plate 740 and the negative electrode plate 750, the plurality of positive electrode layers 713a and the plurality of negative electrode layers 713a are laminated in a state where the separator 761 or 762 is disposed between the positive electrode layer 713a and the negative electrode layer 713a. The electrode body main portion 710 is formed by laminating the plurality of positive electrode layers 713a, the plurality of negative electrode layers 713a, and the separators 761 and 762.

Among the plurality of layers 713a, each of two or more continuous layers 713a includes one or more electrode holes 731 which are through holes penetrating both the current collector foil and the active material layer. FIGS. 6A and 6B illustrate four continuous layers 713a (two positive electrode layers 713a and two negative electrode layers 713a). Each of the two positive electrode layers 713a includes one or more electrode holes 731 (three positive electrode holes 740a in FIGS. 6A and 6B) which are through holes penetrating both the positive electrode current collector foil 741 and the positive electrode active material layer 742. The positive electrode hole 731 (electrode hole 740a) is a circular through hole penetrating, in the Y-axis direction, the positive electrode current collector foil 741 and the positive electrode active material layers 742 provided on both surfaces of the positive electrode current collector foil 741 in the Y-axis direction. Each of the two negative electrode layers 713a includes one or more electrode holes 731 (three negative electrode holes 750a in FIGS. 6A and 6B) which are through holes penetrating both the negative electrode current collector foil 751 and the negative electrode active material layer 752. The negative electrode hole 731 (electrode hole 750a) is a circular through hole penetrating, in the Y-axis direction, the negative electrode current collector foil 751 and the negative electrode active material layers 752 provided on both surfaces of the negative electrode current collector foil 751 in the Y-axis direction. The shape of the electrode hole 731 (electrode hole 740a, electrode hole 750a) is not limited to a circular shape, and may be any shape such as an elliptical shape, an oblong shape, a polygonal shape such as a rectangle, or a slit.

An opening area of the electrode holes 731 (electrode hole 740a, electrode hole 750a) is about 0.02 mm² or less. When the electrode hole 731 has a circular shape, the diameter of the electrode hole 731 is about 0.16 mm or less (the radius thereof is about 0.08 mm or less), for example. With the electrode hole 731 of this size, even when two adjacent electrode holes 731 are connected to form an electrode hole having an opening area of about 0.04 mm² (or an electrode hole having a width of about 0.16 mm×a length of about 0.32 mm), since it is still a small electrode hole, defects such as lithium deposition are unlikely to occur, for example. On the other hand, in a case of electrode holes having an opening area larger than about 0.02 mm², for example, when two adjacent electrode holes are connected to each other, defects such as lithium deposition may occur. The opening area of the electrode holes 731 is preferably about 0.01 mm² or less (or a diameter of about 100 μm or less), more preferably about 0.002 mm² or less (or a diameter of 50 μm or less), and further preferably about 0.0003 mm² or less (or a diameter of about 20 μm or less), for example.

From the viewpoint of permeability of the electrolyte solution into the electrode body 700, the opening area of the electrode holes 731 is preferably about 0.00002 mm² or more (or a diameter of about 5 μm or more). The opening area of the electrode holes 731 is more preferably about 0.00005 mm² or more (or a diameter of about 10 μm or more), and further preferably about 0.0002 mm² or more (or a diameter of about 15 μm or more), for example. The method of forming (processing) the electrode hole 731 is not particularly limited, but by using an ultrashort pulse laser with high power density, such as a picosecond laser or a femtosecond laser, the electrode hole 731 having a small opening area (small diameter) can be processed. The separator 760 disposed between two or more continuous layers 713a (adjacent positive electrode plates 740 and negative electrode plates 750) has micropores, thereby facilitating permeation of the electrolyte solution and exhaust of gas in the separator 760. Therefore, it is not necessary to form a through hole in the separator 760. If the micropores are regarded as through holes, it can also be said that through holes are arranged in the separator 760 between the two or more continuous layers 713a. Therefore, in the present example embodiment, no through holes such as the electrode holes 731 are formed in the separator 760, but through holes such as the electrode holes 731 may also be formed in the separator 760 (one or both of the separators 761 and 762). When forming the through holes in the separator 760, the arrangement of the through holes of the separator 760 may be within the range of the electrode hole group 730 or outside the range of the electrode hole group 730.

In the present example embodiment, the three electrode holes 740a provided in the positive electrode layer 713a and the three electrode holes 750a provided in the negative electrode layer 713a, with the separator 761 interposed therebetween, are arranged at positions shifted (different positions) in the X-axis direction and the Z-axis direction when viewed from the Y-axis direction. Any one of the three electrode holes 740a and any one of the three electrode holes 750a may be arranged at the same position (a position where the electrode holes partially or entirely overlap) in one or both of the X-axis direction and the Z-axis direction when viewed from the Y-axis direction. The same applies to the three electrode holes 740a and the three electrode holes 750a provided in the positive electrode layer 713a and the negative electrode layer 713a, with the separator 762 interposed therebetween. The same applies to the electrode holes 740a in different positive electrode layers 713a, and the same applies to the electrode holes 750a in different negative electrode layers 713a. That is, in two or more continuous layers 713a, electrode holes 731 provided in different layers 713a may be arranged at the same position, or arranged at shifted positions (a position where the electrode holes partially overlap or are separated from each other) when viewed from the Y-axis direction.

As described above, by forming the electrode holes 731 in the plurality of layers 713a of the active material portion 713 and laminating the plurality of layers 713a, an electrode hole group 730 is formed in the electrode body 700 as illustrated in FIG. 5. Specifically, when viewed from the Y-axis direction (second direction), the electrode body 700 has an electrode hole group 730 across each layer 713a of the two or more layers 713a, the electrode holes 731 of each layer 713a being densely arranged within a predetermined region R1. In other words, in the electrode hole group 730, the electrode holes 731 of each layer 713a are arranged concentratedly (intensively) within the predetermined region R1 when viewed from the Y-axis direction. That is, the electrode holes 731 are denser (more concentrated) within the predetermined region R1 than in a region surrounding the predetermined region R1. The density of the electrode holes 731 is higher (the number of electrode holes 731 per unit area is larger) within the predetermined region R1 than in the region surrounding the predetermined region R1.

In the present example embodiment, a maximum width of the predetermined region R1 is smaller than about 50 mm when viewed from the Y-axis direction (second direction). The predetermined region R1 is a region smaller than a region R2 having a diameter of about 50 mm, for example. In FIG. 5, the width of the predetermined region R1 in the Z-axis direction is the longest, and is smaller than about 50 mm, for example. That is, the width of the predetermined region R1 in the Z-axis direction is longer than the width of the predetermined region R1 in the X-axis direction. Thus, even when the electrode plates (the positive electrode plate 740 and the negative electrode plate 750) are wound and the positions of the electrode holes 731 are shifted in the Z-axis direction, the plurality of electrode holes 731 can be arranged within the predetermined region R1 (the electrode plates need not be wound with high precision). In the present example embodiment, the electrode hole group 730 has a substantially elliptical shape long in the Z-axis direction when viewed from the Y-axis direction. The electrode hole group 730 may have a circular shape, a polygonal shape, or any other shape when viewed from the Y-axis direction. By adjusting the formation positions of the electrode holes 731, the width of the predetermined region R1 in the Z-axis direction may be made shorter than the width of the predetermined region R1 in the X-axis direction. The maximum width of the predetermined region R1 is preferably about 30 mm or less, more preferably about 10 mm or less, and further preferably about 5 mm or less, for example. The minimum width of the predetermined region R1 is preferably about 0.1 mm or more, more preferably about 1 mm or more, and further preferably about 2 mm or more, for example.

As illustrated in FIGS. 4 to 6, in the electrode hole group 730, each layer 713a of the two or more continuous layers 713a includes a plurality of electrode holes 731 (three electrode holes 731 in the present example embodiment). In FIGS. 6A and 6B, each layer 713a of the positive electrode includes three electrode holes 740a, and each layer 713a of the negative electrode includes three electrode holes 750a. Further, in the electrode hole group 730, the electrode holes 731 are provided in all layers 713a of the positive electrode plate 740 and the negative electrode plate 750. Specifically, in the electrode hole group 730, the electrode holes 731 are provided in all layers 713a of the plurality of layers 713a of the active material portion 713 of the positive electrode plate 740 and the plurality of layers 713a of the active material portion 713 of the negative electrode plate 750. That is, in the electrode hole group 730, the plurality of electrode holes 731 are provided in all layers 713a of the positive electrode plate 740 and the negative electrode plate 750.

Two or more electrode hole groups 730 are formed in the electrode body 700. In the present example embodiment, nine electrode hole groups 730 (electrode hole groups 730a to 730i) are formed in each flat portion 712 of the electrode body main portion 710 of the electrode body 700. Specifically, in the flat portion 712 of the electrode body main portion 710 in the Y-axis negative direction, the electrode hole groups 730a, 730b, and 730c are arranged in the Z-axis direction at the end of the electrode body main portion 710 in the X-axis negative direction. The electrode hole groups 730d, 730e, and 730f are arranged in the Z-axis direction at the center of the electrode body main portion 710 in the X-axis direction. The electrode hole groups 730g, 730h, and 730i are arranged in the Z-axis direction at the end of the electrode body main portion 710 in the X-axis positive direction. In other words, the electrode hole groups 730a, 730d, and 730g are arranged in the X-axis direction at the end of the electrode body main portion 710 in the Z-axis positive direction. The electrode hole groups 730b, 730e, and 730h are arranged in the X-axis direction at the center of the electrode body main portion 710 in the Z-axis direction. The electrode hole groups 730c, 730f, and 730i are arranged in the X-axis direction at the end of the electrode body main portion 710 in the Z-axis negative direction.

In the flat portion 712 of the electrode body main portion 710 in the Y-axis positive direction, arrangement positions of the nine electrode hole groups 730 (electrode hole groups 730a to 730i) formed in the flat portion 712 of the electrode body main portion 710 in the Y-axis negative direction are upside down (the positions in the Z-axis direction are reversed). That is, in the flat portion 712 of the electrode body main portion 710 in the Y-axis positive direction, the electrode hole groups 730a, 730d, and 730g are arranged in the X-axis direction at the end of the electrode body main portion 710 in the Z-axis negative direction, and the electrode hole groups 730c, 730f, and 730i are arranged in the X-axis direction at the end of the electrode body main portion 710 in the Z-axis positive direction. Each electrode hole group 730 formed in the flat portion 712 of the electrode body main portion 710 in the Y-axis negative direction and each electrode hole group 730 formed in the flat portion 712 of the electrode body main portion 710 in the Y-axis positive direction have the same configuration. FIG. 5 illustrates nine electrode hole groups 730 (electrode hole groups 730a to 730i) formed in the flat portion 712 of the electrode body main portion 710 in the Y-axis negative direction, and the nine electrode hole groups 730 will be described below.

In each of these nine electrode hole groups 730 (electrode hole groups 730a to 730i), the electrode holes 731 (electrode holes 731a to 731i) provided in each layer 713a are densely arranged within the predetermined region R1. In this way, since the electrode holes 731 are dense in the electrode hole group 730, the distance between the electrode holes 731 in the electrode hole group 730 becomes smaller than the distance between two adjacent electrode hole groups 730 (such as a first distance A1 or a second distance A2 described below). That is, the distance between the electrode holes 731 within the electrode hole group 730 is smaller than the distance between two adjacent electrode hole groups 730 included the electrode hole group when viewed from the Y-axis direction (second direction).

In FIGS. 4 and 5, in the electrode hole groups 730a to 730i, each of the electrode holes 731a to 731i is densely arranged at a similar arrangement position, but the electrode holes 731a to 731i may be densely arranged when the electrode body 700 is formed, and individual arrangement positions thereof are not particularly limited.

A distance between two adjacent electrode hole groups 730 in the X-axis direction (first direction) is defined as a first distance A1. A distance between two adjacent electrode hole groups 730 in the Z-axis direction (third direction orthogonal to the first direction and the second direction) is defined as a second distance A2. The distance between the two electrode hole groups 730 in the X-axis direction is defined as a distance in the X-axis direction between an end edge on the X-axis positive direction side of the electrode hole group 730 located in the X-axis negative direction and an end edge on the X-axis negative direction side of the electrode hole group 730 located in the X-axis positive direction. The same applies to the distance between the two electrode hole groups 730 in the Z-axis direction.

That is, when two predetermined adjacent electrode hole groups 730 among the plurality of electrode hole groups 730 (nine electrode hole groups 730 in the present example embodiment) are targeted, the distance between the two electrode hole groups 730 in the X-axis direction is defined as the first distance A1, and the distance in the Z-axis direction is defined as the second distance A2. In FIG. 5, the electrode hole group 730a and the electrode hole group 730e are targeted as an example of two adjacent electrode hole groups 730, and the distance between the electrode hole group 730a and the electrode hole group 730e in the X-axis direction is illustrated as the first distance A1, and the distance in the Z-axis direction is illustrated as the second distance A2. When the electrode hole group 730a and the electrode hole group 730d are targeted as an example of two adjacent electrode hole groups 730, the distance between the electrode hole group 730a and the electrode hole group 730d in the X-axis direction is the first distance A1 in FIG. 5, but the second distance A2 in the Z-axis direction is zero.

In such a configuration, the first distance A1 is larger than the second distance A2. Specifically, the first distance A1 is larger than about 10 times the second distance A2, for example. The first distance A1 is more preferably larger than about 20 times the second distance A2, and further preferably larger than about 50 times the second distance A2, for example. In the present example embodiment, the first distance A1 is about 100 mm or more, for example. The first distance A1 is preferably about 125 mm or more, and more preferably about 150 mm or more, for example. From the viewpoint of permeability of the electrolyte solution into the electrode body 700, the first distance A1 is preferably about 90 times or less the second distance A2, and further preferably 70 times or less, for example. The first distance A1 is preferably about 250 mm or less, and more preferably about 200 mm or less, for example. As described above, the plurality of electrode hole groups 730 (nine electrode hole groups 730 in the present example embodiment) include two electrode hole groups 730 having a relationship in which the first distance A1 is larger than the second distance A2 (larger than about 10 times the second distance A2, etc.).

In the present example embodiment, the nine electrode hole groups 730 are arranged in a lattice pattern such that three electrode hole groups 730 are aligned at intervals of the first distance A1 in the X-axis direction, and three sets thereof are arranged at intervals of the second distance A2 in the Z-axis direction. Therefore, a distance between any two electrode hole groups 730 adjacent in the X-axis direction is defined as the first distance A1 and a distance between any two electrode hole groups 730 adjacent in the Z-axis direction is defined as the second distance A2, and the first distance A1 can be said to be larger than the second distance A2, defining. In FIG. 5, the distance in the X-axis direction between the electrode hole group 730a and the electrode hole group 730d adjacent in the X-axis direction is the first distance A1, the distance in the Z-axis direction between the electrode hole group 730a and the electrode hole group 730b adjacent in the Z-axis direction is the second distance A2, and the first distance A1 is larger than the second distance A2. In this way, the plurality of electrode hole groups 730 (nine electrode hole groups 730 in the present example embodiment) include at least three electrode hole groups 730 having a relationship in which the first distance A1 is larger than the second distance A2 (larger than about 10 times the second distance A2, etc.).

By forming the electrode hole groups 730 (electrode holes 731) in the electrode body 700, the effective electrode area of the electrode body 700 decreases, and the capacity of the energy storage device 10 decreases (capacity loss occurs). The effective electrode area of the electrode body 700 is an area of a region where the active material layer is arranged (region where the active material portion 713 is arranged) in the electrode plate. A ratio at which the effective electrode area decreases is referred to as an opening area ratio. The opening area ratio is a ratio of a total opening area of all the electrode holes 731 provided in the active material portion 713 to an area of the active material portion 713. Specifically, the opening area ratio is a ratio of the total opening area of all the electrode holes 731 provided in the active material portion 713 to the area of the active material portion 713 when the winding state of the electrode body 700 is developed to spread the electrode plate and the electrode plate is viewed in plan.

The opening area ratio is preferably about 3% or less, more preferably about 1% or less, and further preferably about 0.5% or less from the viewpoint of reducing or preventing a decrease in capacity of the energy storage device 10, for example. The opening area ratio is preferably about 0.001% or more, and more preferably about 0.01% or more from the viewpoint of improving permeability of the electrolyte solution into the electrode body 700, for example. As described above, the opening area ratio can also be said to be a ratio of an amount of decrease in capacity (capacity loss) of the energy storage device 10 caused by the electrode holes 731. Therefore, a ratio of the amount of decrease in capacity (capacity loss) of the energy storage device 10 is also preferably about 3% or less, more preferably about 1% or less, and further preferably about 0.5% or less, for example. The ratio of the amount of decrease in capacity (capacity loss) of the energy storage device 10 is preferably about 0.001% or more, and more preferably about 0.01% or more, for example.

As described above, in the energy storage device 10 according to the present example embodiment of the present invention, each layer 713a of the two or more continuous layers 713a of the active material portion 713 of the wound electrode plates (the positive electrode plate 740 and the negative electrode plate 750) of the electrode body 700 includes the electrode holes 731 having an opening area of about 0.02 mm² or less, for example. In the electrode body 700, the electrode hole group 730 in which the electrode holes 731 of each layer 713a are densely arranged within the predetermined region R1 is formed when viewed from the second direction (Y-axis direction). Thus, although it is difficult for the electrolyte solution to permeate into the electrode body 700 in which the electrode plates are wound, since the electrode hole group 730 in which the electrode holes 731 of each layer 713a in the active material portion 713 are densely arranged within the predetermined region R1 is formed in the electrode body 700, the electrolyte solution can be easily permeated into the electrode body 700 via the respective electrode holes 731 of the electrode hole group 730. Since the electrode body 700 has an elongated shape having a long length in the winding axis direction (X-axis direction), it is difficult to permeate the electrolyte solution, but as described above, since the electrode hole groups 730 are formed in the electrode body 700, the electrolyte solution can be easily permeated into the electrode body 700. Since the electrode hole 731 is a minute electrode hole 731 having an opening area of about 0.02 mm² or less, for example it is possible to reduce or prevent defects such as a risk of a micro short circuit occurring due to burrs or contamination, or a decrease in capacity (a decrease in energy density) due to a decrease in an effective electrode area. Thus, the electrolyte solution can be easily permeated into the electrode body 700 while reducing or preventing defects.

When gas is generated and accumulated inside the electrode body 700 during use of the energy storage device 10, since the gas can be exhausted from the electrode hole groups 730 (particularly, the electrode hole groups 730a, 730d, 730g), a decrease in capacity due to expansion of an inactive region caused by formation of a gas pocket can be reduced or prevented. When the electrolyte solution inside the electrode body 700 is consumed and dry-out of electrolyte solution occurs, since the electrolyte solution can be replenished into the electrode body 700 from the electrode hole groups 730 (particularly, the electrode hole groups 730c, 730f, 730i), a decrease in capacity due to expansion of an inactive region caused by the dry-out at the end of life can be reduced or prevented.

Since the electrode hole 731 is a minute through hole, lithium deposition is unlikely to occur even if the position of the electrode hole 731 is not aligned. That is, deposition is unlikely to occur even when there is no negative electrode active material facing the positive electrode active material. Even if minute deposition occurs, since the occurrence is local, there is a high possibility that the deposition is eliminated by self-diffusion of lithium ions in the electrode plate during use of the energy storage device 10. When the minute electrode holes 731 are formed by a laser (picosecond laser or femtosecond laser, etc.), since components of the electrode plate evaporate, contamination of several tens of microns in size which may cause a micro short circuit failure is unlikely to occur. When the minute electrode holes 731 are formed in the electrode plate, since thermal effect from the laser is small, it is possible to reduce or prevent alteration of the surrounding active material due to heat. When the electrode hole 731 having a diameter of 5 μm or more is formed, the electrolyte solution can be relatively easily permeated into the electrode body 700, and a hole having a diameter of 5 μm or more can be formed by a laser (picosecond laser or femtosecond laser, etc.). By forming the minute electrode holes 731 in the electrode plate, it is possible to reduce or prevent contamination of a roll by paste passing through the electrode holes 731 at the time of coating the active material, and stable coating can be performed.

By setting the size of the predetermined region R1, within which the electrode holes 731 of each layer 713a are densely arranged in the electrode hole group 730, to be smaller than about 50 mm, the electrode holes 731 of each layer 713 a are brought closer to each other, so that permeability of the electrolyte solution into each layer 713a via the electrode holes 731 can be improved. Permeability of the electrolyte solution can be improved by bringing two or more electrode holes 731 in one layer 713a closer to each other, and permeability of the electrolyte solution can also be improved by bringing electrode holes 731 included in two or more adjacent layers 713a closer to each other. If the number of electrode holes 731 can be reduced by densely arranging the electrode holes 731 within the small predetermined region R1, a decrease in the effective electrode area can be reduced or prevented.

By providing a plurality of electrode holes 731 in each layer 713a in the electrode hole group 730, the electrolyte solution can be efficiently permeated into each layer 713a via the plurality of electrode holes 731. By providing a plurality of electrode holes 731 in each layer 713a, gas can be efficiently exhausted from the electrode hole group 730 when gas is generated inside the electrode body 700, and the electrolyte solution can be efficiently replenished into the electrode body 700 from the electrode hole group 730 when dry-out of the electrolyte solution occurs.

In the electrode hole group 730, by providing electrode holes 731 in all layers 713a of the active material portion 713 of the positive electrode plate 740 and the negative electrode plate 750, the electrolyte solution can be permeated into all the layers 713a of the positive electrode plate 740 and the negative electrode plate 750, so that the electrolyte solution can be more effectively permeated into the electrode body 700. By providing electrode holes 731 in all layers 713a of the positive electrode plate 740 and the negative electrode plate 750, gas can be more effectively exhausted from the electrode hole group 730 when gas is generated inside the electrode body 700, and the electrolyte solution can be more effectively replenished into the electrode body 700 from the electrode hole group 730 when dry-out of the electrolyte solution occurs.

By setting the ratio of the total opening area of all the electrode holes 731 to the area of the active material portion 713 to be as small as about 3% or less, a decrease in the effective electrode area caused by providing the electrode holes 731 in the active material portion 713 can be reduced or prevented. When reducing the ratio of the total opening area of the electrode holes 731, since the opening area of the electrode holes 731 is reduced or the number of the electrode holes 731 is decreased, the risk of a micro short circuit occurring due to burrs or contamination can be reduced.

The distance between the electrode holes 731 within the electrode hole group 730 is smaller than the distance between two adjacent electrode hole groups 730 included the electrode hole group when viewed from the second direction (Y-axis direction). In this way, since the distance between the electrode holes 731 in the electrode hole group 730 is relatively small, the electrolyte solution can be effectively permeated into the electrode body 700. The distance between two adjacent electrode hole groups 730 is larger than the distance between the electrode holes 731 in the electrode hole group 730 when viewed from the second direction (Y-axis direction). In this way, since the distance between two adjacent electrode hole groups 730 is relatively large, damage to the electrode plate, such as breakage of the electrode plate (the positive electrode plate 740 or the negative electrode plate 750) between the two electrode hole groups 730, can be reduced or prevented.

The first distance A1 between the two electrode hole groups 730 in the first direction (X-axis direction) is set to be larger than the second distance A2 between the two electrode hole groups 730 in the third direction (Z-axis direction). In this way, by distributing the electrode hole groups 730 at a constant distance (the first distance A1 in the first direction and the second distance A2 in the third direction), a decrease in the effective electrode area caused by providing the electrode holes 731 can be reduced or prevented. By increasing the distance (first distance A1) between the electrode hole groups 730 in the first direction (X-axis direction), damage to the electrode plate, such as breakage of the electrode plate (the positive electrode plate 740 or the negative electrode plate 750) between the electrode hole groups 730, can be further reduced or prevented. In particular, since the electrode body 700 is formed by winding the electrode plates (the positive electrode plate 740 and the negative electrode plate 750), the electrode plates are wound while being pulled in a direction perpendicular to the winding axis L, that is, in the second direction (Y-axis direction). For this reason, when the distance between the electrode hole groups 730 in the first direction (X-axis direction) (first distance A1) is small, tension is concentrated on the active material portion 713 between adjacent electrode hole groups 730, and the active material portion 713 is susceptible to breakage. Therefore, by increasing the first distance A1, damage to the electrode plate, such as breakage of the electrode plate between the electrode hole groups 730, can be further reduced or prevented.

By setting the first distance A1 to be larger than about 10 times the second distance A2, the electrode hole groups 730 are distributed at a large interval in the first direction (X-axis direction), so that a decrease in the effective electrode area caused by providing the electrode holes 731 can be further reduced or prevented. By setting the first distance A1 to be larger than about 10 times the second distance A2, the distance between the electrode hole groups 730 in the first direction (X-axis direction) is further increased, so that damage to the electrode plate, such as breakage of the electrode plate (the positive electrode plate 740 or the negative electrode plate 750) between the electrode hole groups 730, can be further reduced or prevented.

Although the energy storage devices according to the example embodiments of the present invention have been described above, the present invention is not limited to the above example embodiments. The example embodiments disclosed herein are illustrative in all aspects, and the scope of the present invention includes all modifications within the meaning and scope of the claims and their equivalents.

In the above example embodiments, the number and positions of the electrode holes 731 and the electrode hole groups 730 formed in the electrode body 700 are not particularly limited. That is, any number of electrode hole groups 730 may be formed at any position of the electrode body 700, and any number of electrode holes 731 may be formed at any position in the electrode hole group 730.

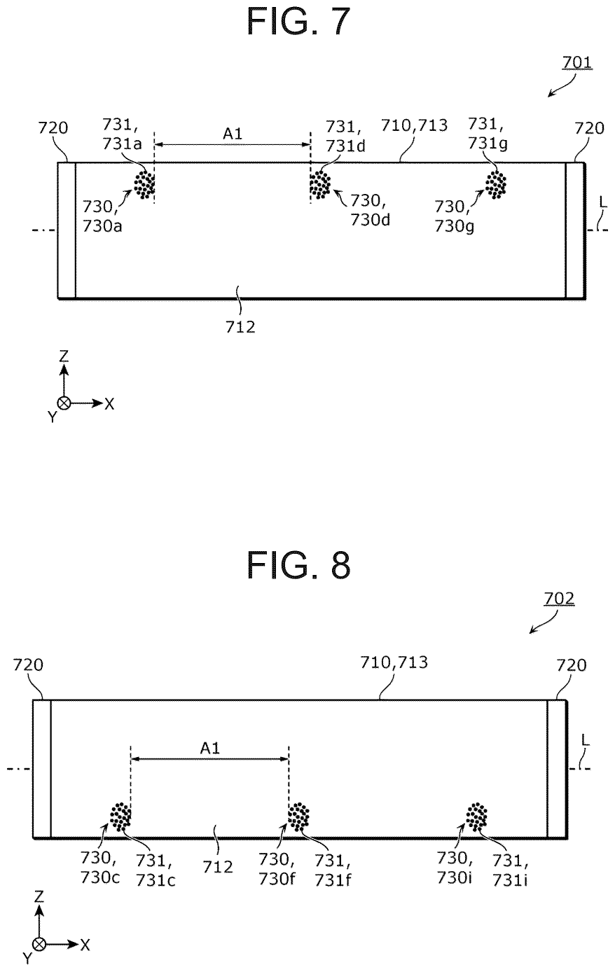

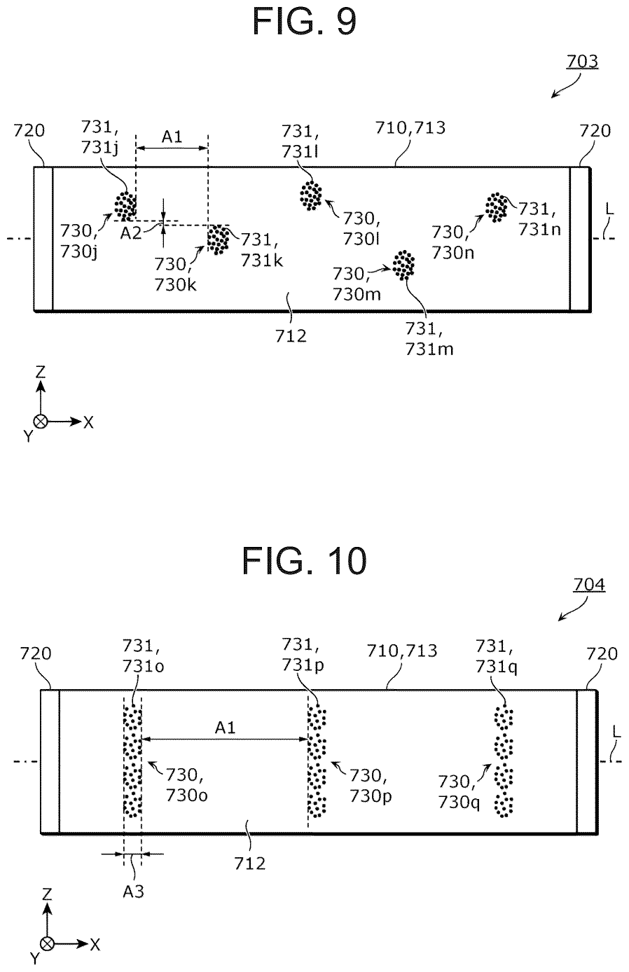

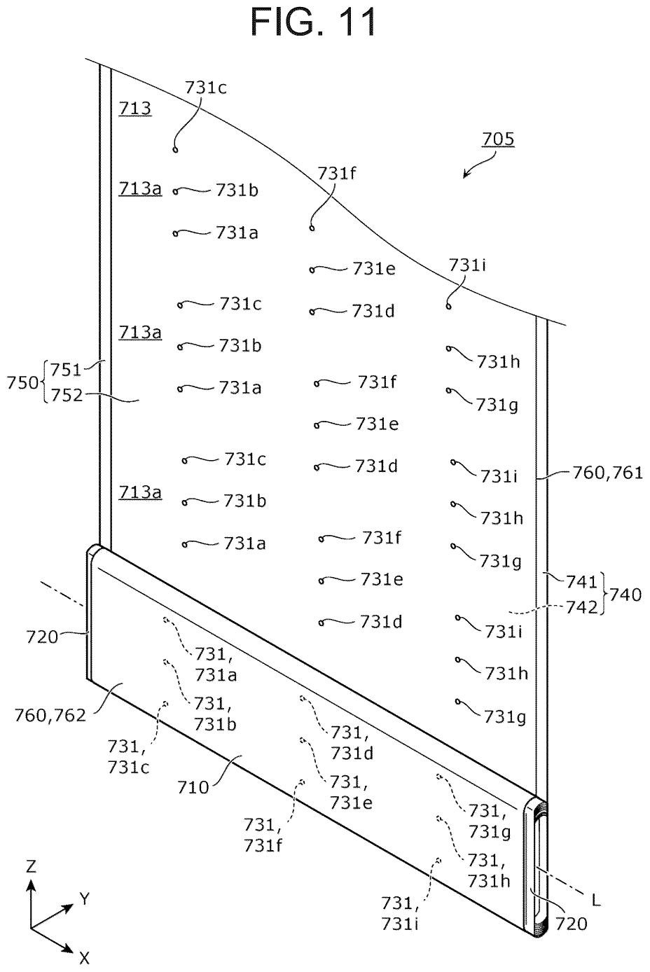

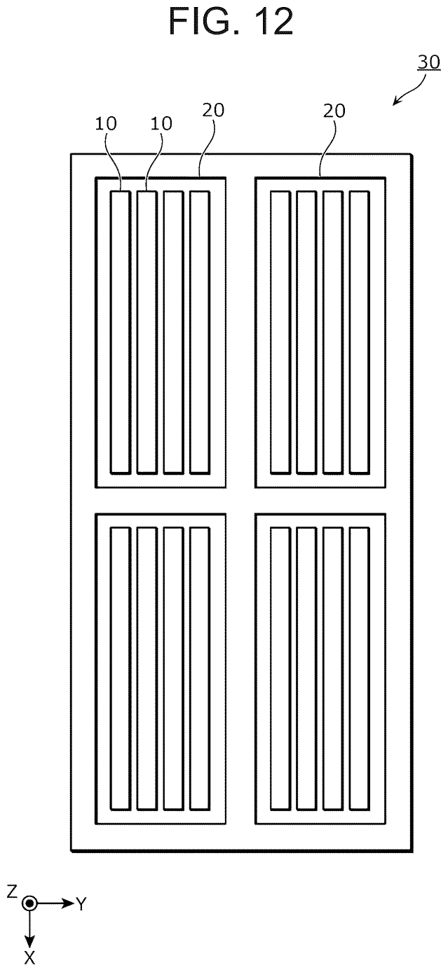

FIG. 7 is a front view illustrating configurations of electrode holes 731 and electrode hole groups 730 of an electrode body 701 according to Modification Example 1 of the present example embodiment. FIG. 8 is a front view illustrating configurations of electrode holes 731 and electrode hole groups 730 of an electrode body 702 according to Modification Example 2 of the present example embodiment. FIG. 9 is a front view illustrating configurations of electrode holes 731 and electrode hole groups 730 of an electrode body 703 according to Modification Example 3 of the present example embodiment. FIG. 10 is a front view illustrating configurations of electrode holes 731 and electrode hole groups 730 of an electrode body 704 according to Modification Example 4 of the present example embodiment. FIGS. 7 to 10 are views corresponding to FIG. 5A. In FIGS. 7 to 10, similarly to FIG. 5, for convenience of explanation, the electrode holes 731 and the electrode hole groups 730 formed in the flat portion 712 in the Y-axis negative direction of the electrode body main portion 710 are illustrated as viewed through the electrode plates (the positive electrode plate 740 and the negative electrode plate 750) and the separator 760 of the electrode bodies 701 to 704. In each modification example, the electrode holes 731 and the electrode hole groups 730 having the same configuration as those of the flat portion 712 in the Y-axis negative direction of the electrode body main portion 710 are also formed in the flat portion 712 in the Y-axis positive direction of the electrode body main portion 710. FIG. 11 is a perspective view illustrating a configuration of electrode holes 731 included in an electrode hole group 730 of an electrode body 705 according to Modification Example 5 of the present example embodiment. FIG. 11 is a view corresponding to FIG. 4.

As illustrated in FIG. 7, in the electrode body 701 in Modification Example 1, three electrode hole groups 730 (electrode hole groups 730a, 730d, and 730g) provided at the end of the electrode body 700 in the Z-axis positive direction in the above example embodiments are formed. Also in the present modification example, in the flat portion 712 in the Y-axis negative direction, the first distance A1, which is a distance in the X-axis direction between two adjacent electrode hole groups 730 (the electrode hole group 730a and the electrode hole group 730d in FIG. 7), is larger than the second distance A2, which is a distance in the Z-axis direction (not illustrated because it is zero) (larger than about 10 times the second distance A2). The same applies to the flat portion 712 in the Y-axis positive direction. Other configurations of the present modification example are the same as those of the above example embodiments, and thus detailed description thereof will be omitted. According to the present modification example, the same effects as those of the above example embodiments can be obtained. In particular, by reducing the number of electrode hole groups 730, it is possible to reduce or prevent defects such as a risk of a micro short circuit occurring due to burrs or contamination associated with formation of the electrode holes 731, or a decrease in capacity due to a decrease in an effective electrode area. When gas is generated and accumulated inside the electrode body 701 during use of the energy storage device 10, since the gas can be exhausted from the electrode hole group 730, a decrease in capacity due to expansion of an inactive region caused by formation of a gas pocket can be reduced or prevented.

As illustrated in FIG. 8, in the electrode body 702 in Modification Example 2, three electrode hole groups 730 (electrode hole groups 730c, 730f, and 730i) provided at the end of the electrode body 700 in the Z-axis negative direction in the above example embodiments are formed. Also in the present modification example, in the flat portion 712 in the Y-axis negative direction, the first distance A1, which is a distance in the X-axis direction between two adjacent electrode hole groups 730 (the electrode hole group 730c and the electrode hole group 730f in FIG. 8), is larger than the second distance A2, which is a distance in the Z-axis direction (not illustrated because it is zero) (larger than about 10 times the second distance A2). The same applies to the flat portion 712 in the Y-axis positive direction. Other configurations of the present modification example are the same as those of the above example embodiments, and thus detailed description thereof will be omitted. According to the present modification example, the same effects as those of the above example embodiments can be obtained. In particular, by reducing the number of electrode hole groups 730, it is possible to reduce or prevent defects such as a risk of a micro short circuit occurring due to burrs or contamination associated with formation of the electrode holes 731, or a decrease in capacity due to a decrease in an effective electrode area. When the electrolyte solution inside the electrode body 702 is consumed and dry-out of electrolyte solution occurs, since the electrolyte solution can be replenished into the electrode body 702 from the electrode hole groups 730, a decrease in capacity due to expansion of an inactive region caused by the dry-out at the end of life can be reduced or prevented.

As illustrated in FIG. 9, in the electrode body 703 in Modification Example 3, five electrode hole groups 730 (electrode hole groups 730j, 730k, 730l, 730m, and 730n) each including electrode holes 731 (electrode holes 731j, 731k, 731l, 731m, and 731n) are formed in the flat portion 712 in the Y-axis negative direction. The five electrode hole groups 730 are aligned in the X-axis direction, and are arranged so that their positions in the Z-axis direction are shifted alternately (a staggered arrangement). In the present modification example, a distance between two adjacent electrode hole groups 730 in the X-axis direction (first direction) is defined as a first distance A1, a distance between two adjacent electrode hole groups 730 in the Z-axis direction (third direction) is defined as a second distance A2, and the first distance A1 is larger than the second distance A2. In FIG. 9, the electrode hole group 730j and the electrode hole group 730k are targeted as an example of two adjacent electrode hole groups 730, and the distance in the X-axis direction between the electrode hole group 730j and the electrode hole group 730k is illustrated as the first distance A1, and the distance in the Z-axis direction is illustrated as the second distance A2. The first distance A1 is larger than about 10 times the second distance A2. The same applies to the flat portion 712 in the Y-axis positive direction. Other configurations of the present modification example are the same as those of the above example embodiments, and thus detailed description thereof will be omitted. According to the present modification example, the same effects as those of the above example embodiments can be obtained. In particular, by reducing the number of electrode hole groups 730, it is possible to reduce or prevent defects such as a risk of a micro short circuit occurring due to burrs or contamination associated with formation of the electrode holes 731, or a decrease in capacity due to a decrease in an effective electrode area.

As illustrated in FIG. 10, in the electrode body 704 in Modification Example 4, three electrode hole groups 730 (electrode hole groups 730o, 730p, and 730q) each including electrode holes 731 (electrode holes 731o, 731p, and 731q) are formed in the flat portion 712 in the Y-axis negative direction. The three electrode hole groups 730 are elongated in the Z-axis direction and are arranged in the X-axis direction. In the present modification example, the first distance A1, which is a distance in the X-axis direction between two adjacent electrode hole groups 730 (the electrode hole group 730o and the electrode hole group 730p in FIG. 10), is larger than the second distance A2, which is a distance in the Z-axis direction (not illustrated because it is zero) (larger than about 10 times the second distance A2). In the present modification example, each of the electrode hole groups 730 is formed in a strip shape extending in the Z-axis direction, and a width A3 of the electrode hole group 730 in the X-axis direction is about 20 mm. In each of the electrode hole groups 730, circular or elliptical aggregates including a plurality of electrode holes 731 are arranged so as to be aligned in the Z-axis direction. In each electrode hole group 730, one or more electrode holes 731 among the plurality of electrode holes 731 illustrated in FIG. 10 may be formed in each layer 713a of the active material portion 713, and any number of electrode holes 731 may be formed. In one electrode hole group 730, a plurality of electrode holes 731 may be arranged so as to be aligned in a zigzag manner. The same applies to the flat portion 712 in the Y-axis positive direction. Other configurations of the present modification example are the same as those of the above example embodiments, and thus detailed description thereof will be omitted. According to the present modification example, the same effects as those of the above example embodiments can be obtained. In particular, since each electrode hole group 730 extends in the Z-axis direction, gas can be efficiently exhausted from the electrode holes 731 in the Z-axis positive direction, and the electrolyte solution can be replenished into the electrode body 704 from the electrode holes 731 in the Z-axis negative direction.

As illustrated in FIG. 11, in the electrode body 705 in Modification Example 5, the electrode holes 731 (electrode holes 731a to 731i) provided in the electrode body 700 in the above example embodiments are formed. However, in the present modification example, the number of electrode holes 731 formed in one electrode hole group 730 is only one in each layer 713a of the active material portion 713. That is, in the present modification example, any one electrode hole 731 among the three electrode holes 731 included in one electrode hole group 730 and provided in each layer 713a in the above example embodiments is formed in each layer 713a. In FIG. 11, similarly to FIG. 4, the size of the electrode holes 731 is illustrated in an enlarged manner. The electrode hole group 730 is formed by densely arranging one electrode hole 731 formed in each layer 713a within a predetermined region when viewed from the Y-axis direction. Since the electrode hole group 730 formed in the electrode body 705 has a configuration similar to that illustrated in FIG. 5, in which the electrode holes 731 of each layer 713a are densely arranged, illustration and detailed description of the electrode hole group 730 are omitted. Other configurations of the present modification example are the same as those of the above example embodiments, and thus detailed description thereof will be omitted. According to the present modification example, the same effects as those of the above example embodiments can be obtained. In particular, by reducing the number of electrode holes 731, it is possible to reduce or prevent defects such as a risk of a micro short circuit occurring due to burrs or contamination associated with formation of the electrode holes 731, or a decrease in capacity due to a decrease in an effective electrode area.

The energy storage device 10 may be used in an energy storage apparatus. In this case, the technique of the present invention may be applied to at least one energy storage device 10 included in the energy storage apparatus. FIG. 12 is a plan view illustrating an example of an energy storage apparatus 30 according to Modification Example 6 of the present example embodiment. As illustrated in FIG. 12, a plurality of energy storage units 20 are arranged inside the energy storage apparatus 30. The energy storage unit 20 includes a plurality of energy storage devices 10 electrically connected. The energy storage apparatus 30 may include a bus bar (not illustrated) electrically connecting the plurality of energy storage devices 10, a bus bar (not illustrated) electrically connecting the plurality of energy storage units 20, and the like. The energy storage unit 20 or the energy storage apparatus 30 may include a state monitoring device (not illustrated) that monitors the state of one or more energy storage devices 10. The energy storage apparatus 30 may include only one energy storage unit 20 (that is, the energy storage unit 20 may be referred to as an energy storage apparatus).

In the above example embodiments (and the above-described Modification Examples 1 to 6, the same applies hereinafter), the electrode hole groups 730 are formed in both the flat portion 712 in the Y-axis negative direction and the flat portion 712 in the Y-axis positive direction of the electrode body main portion 710, but they may be formed in only one of the flat portions 712. The configuration of the electrode hole groups 730 (such as arrangement position, shape, number, number of electrode holes 731 in one electrode hole group 730, etc.) may be different between the flat portion 712 in the Y-axis negative direction and the flat portion 712 in the Y-axis positive direction. The electrode hole group 730 may be formed in the curved portion 711 of the electrode body main portion 710. In Modification Example 1, the electrode hole group 730 may be formed in the curved portion 711 of the electrode body main portion 710 in the Z-axis positive direction. In Modification Example 2, the electrode hole group 730 may be formed in the curved portion 711 of the electrode body main portion 710 in the Z-axis negative direction. When the electrode hole group 730 is formed in the curved portion 711, the second direction (the stacking direction of the plurality of layers 713a) is defined not as the Y-axis direction but as the Z-axis direction or a direction between the Y-axis direction and the Z-axis direction.

In the above example embodiments, all the plurality of electrode hole groups 730 provided in the electrode body main portion 710 have the same configuration, but any one of the electrode hole groups 730 may have a different configuration.

In the above example embodiments, the electrode holes 731 (electrode holes 740a, electrode holes 750a) all have the same shape and the same size (opening area), but any one of the electrode holes 731 may have a different shape or a different size (opening area). The size of the electrode hole 740a may be larger or smaller than the size of the electrode hole 750a.

In the above example embodiments, in the electrode hole group 730, the plurality of electrode holes 731 are provided in all layers 713a of the positive electrode plate 740 and the negative electrode plate 750, but the present invention is not limited thereto. Among all the layers 713a of the positive electrode plate 740 and the negative electrode plate 750, the electrode holes 731 may be provided only in a continuous half of the layers 713a, or the electrode holes 731 may be provided only in one third of the continuous layers 713a or only in one quarter of the continuous layers 713a. Only one electrode hole 731 may be provided in any layer 713a of the positive electrode plate 740 and the negative electrode plate 750. That is, it is sufficient that one or more electrode holes 731 are provided in each of two or more continuous layers 713a among the layers 713a of the positive electrode plate 740 and the negative electrode plate 750.

In the above example embodiments, in a case where priority is given to reduction of time cost at the time of manufacturing, or the like, the opening area ratio may be larger than about 3%, for example.

In the above example embodiments, the maximum width of the predetermined region R1 is smaller than about 50 mm when viewed from the Y-axis direction (second direction), but may be about 50 mm or more, for example.

In the above example embodiments, in the two adjacent electrode hole groups 730, the first distance A1 is larger than about 10 times the second distance A2, but may be about 10 times or less the second distance A2, or may be smaller than the second distance A2, for example.

In the above example embodiments, only one electrode hole group 730 may be provided in the electrode body 700.

In the above example embodiments, the liquid injection part 130 is disposed in the lid body 120 of the container 100, but may be disposed in the container body 110. The liquid injection part 130 may be disposed on the long side wall portion 111 or the bottom wall portion 113 (wall portion of the electrode body 700 extending in the winding axis direction) of the container body 110, or may be disposed on the short side wall portion 112. Although the gas discharge valve 140 is disposed on the lid body 120, it may be disposed on any wall portion of the container body 110.

In the above example embodiments, an inorganic coat layer may be provided on the separator 760 (separators 761, 762). The inorganic coat layer is a coat layer including inorganic particles and a binder, and the inorganic coat layer may be coated on the whole or a part of the surface (one surface or both surfaces) of the separator 760 by the binder. As the binder, a known material can be appropriately used. The inorganic coat layer preferably contains at least one of aluminum silicate, barium sulfate, or alumina (boehmite) as the inorganic particles. The inorganic coat layer preferably has a permeation area of the electrolyte solution of 80 mm² or more at 300 seconds after the electrolyte solution is dropped. When a sheet-like member is disposed on the outer surface of the electrode body 700, a sheet-like porous body having insulating properties may be disposed. It is preferable that the porous body has an air permeability lower than that of the separator 760 (air permeability is about 250 seconds/100 mL or less) because pores larger than those of the separator 760 (about 100 μm or more) are formed, for example. The porous body is preferably formed of a nonwoven fabric such as a polymer nonwoven fabric made of PP. Accordingly, since permeability of the electrolyte solution into the electrode body 700 is improved, the number of electrode hole groups 730 or the number of electrode holes 731 formed in the electrode body 700 can be reduced.

In the above example embodiments, the pair of terminals 300 are both disposed so as to protrude in the Z-axis positive direction from the container 100, but the protruding direction of the terminals 300 is not particularly limited. The pair of terminals 300 may protrude from the container 100 in either of the X-axis directions, or in both of the X-axis directions.

In the above example embodiments, the electrode body 700 has an oblong cylindrical shape (flat shape) including the curved portions 711 and the flat portions 712, but may have a cylindrical shape, an elliptical cylindrical shape, or the like, and the shape is not particularly limited as long as it is a winding type electrode body. In the electrode body 700, the active material non-forming portion 720 may be a tab portion (a portion where a plurality of tabs of electrode plates are laminated) protruding from a part of the electrode body main portion 710. The electrode body 700 does not have to have an elongated shape in the X-axis direction.

Example embodiments constructed by arbitrarily combining elements included in the above-described example embodiments and the modification examples thereof are also included in the scope of the present invention. The various supplementary matters relating to the example embodiments described above may be applied to any of Modification Examples 1 to 6.

Example embodiments of the present invention can be applied to energy storage devices such as lithium-ion secondary batteries.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage device comprising:
an electrode body that includes an electrode plate including a current collector foil and an active material layer; wherein
the electrode plate is wound around a winding axis extending in a first direction and includes an active material portion in which the active material layer is provided on the current collector foil in a second direction orthogonal to the first direction;
the active material portion includes a plurality of layers in the second direction;
each layer of two or more continuous layers among the plurality of layers includes one or more electrode holes that are through holes penetrating both the current collector foil and the active material layer;
an opening area of each electrode hole is about 0.02 mm² or less; and
when viewed from the second direction, the electrode body includes an electrode hole group extending across each layer of the two or more layers, the electrode holes of each layer being located within a predetermined region.

2. The energy storage device according to claim 1, wherein a maximum width of the predetermined region is smaller than about 50 mm when viewed from the second direction.

3. The energy storage device according to claim 1, wherein, in the electrode hole group, the each layer of the two or more layers includes a plurality of the electrode holes.

4. The energy storage device according to claim 1, wherein
the electrode plate includes a positive electrode plate and a negative electrode plate; and
in the electrode hole group, the electrode holes are provided in all layers of the plurality of layers of the active material portion of the positive electrode plate and in all layers of the plurality of layers of the active material portion of the negative electrode plate.

5. The energy storage device according to claim 1, wherein a ratio of a total opening area of all of the electrode holes provided in the active material portion to an area of the active material portion is about 3% or less.

6. The energy storage device according to claim 1, wherein
two or more of electrode hole groups included in the electrode hole group are located in the electrode body; and
a distance between the electrode holes within the electrode hole group is smaller than a distance between two adjacent electrode hole groups included the electrode hole group when viewed from the second direction.

7. The energy storage device according to claim 6, wherein
a distance between the two electrode hole groups in the first direction is defined as a first distance;
a distance between the two electrode hole groups in a third direction orthogonal to the first direction and the second direction is defined as a second distance; and
the first distance is larger than the second distance.

8. The energy storage device according to claim 7, wherein the first distance is larger than about 10 times the second distance.
